(19) United States
(12) Patent Application Publication
(10) Pub. No.: US 2024/0200583 A1
(43) Pub. Date: Jun. 20, 2024

(54) DUAL ORIFICE COMPONENT

(71) Applicant: ZF Off-Highway Solutions Minnesota Inc, North Mankato, MN (US)

(72) Inventor: Peter BACKES, North Mankato, MN (US)

(21) Appl. No.: 18/066,408

(22) Filed: Dec. 15, 2022

(51) Int. Cl. F15D 1/02

(52) U.S. Cl. CPC F15D 1/025

(57) ABSTRACT

A dual orifice component has a plug with a unitary body that defines a central axis and has opposite axial ends. First and second holes are aligned along the central axis and each has first and second axially opposite ends. A third hole extends perpendicular to the central axis and passes through the plug. The first end of the first axial hole is located at one axial end of the plug, and the second end of the first axial hole communicates with and is open to the third hole. The first end of the second axial hole is located at the other axial end of the plug, and the second end of the second axial hole communicates with and is open to the third hole such that the first and the second holes are axially separated from each other by the third hole.

### FIELD OF THE DISCLOSURE

The present invention relates generally to hydraulic systems and more particularly to a dual orifice component for hydraulic systems.

### BACKGROUND

Hydraulic systems often utilize fixed orifices to control the flow of fluid through the system. Fixed orifices are small passages that may be drilled into a short grub screw, set screw, or plug that may then be threaded into the body of a valve or fitting, for example, and create a flow restriction or back pressure. Orifices are connected to two hydraulic chambers which may be considered as high- and low-pressure zones. As hydraulic fluid flows through a fixed orifice from the high-pressure zone to the low-pressure zone it is common for the flow fluid to become turbulent. The changes in pressure and flow velocity as the fluid passes through relatively narrow orifices cause the turbulent flow and often generates heat and abnormal vibration, knocking or so-called flow noise.

It has been found that one way to reduce the flow noise in a hydraulic system is to use two or more orifices in series between the high- and low-pressure zones. The sum of the flow noise through a cascade of orifices in series is less than the flow noise through an equivalent single orifice. In the production of on orifice, it is often most cost effective to drill an orifice in a threaded steel plug and assemble the plug into the valve body for example. To produce components or fittings having orifices in arranged in series, multiple orifices can be installed one in front of the other. This process of assembling one orifice on top of another in series is often referred to as “stacking.” In this manner of production, a first orifice is installed in the component or fitting which is then followed by the installation of a second orifice in the component or fitting. This process of assembling one orifice on top of another in series is often referred to as “stacking”. In series production an End of Line test can be used to detect the absence or presence of the orifice by measuring flow rate from the high-pressure zone to the low-pressure zone.

Although beneficial for their intended purposes, several disadvantages have been found in the use of multiple orifices in series as opposed to the use of a single orifice. One disadvantage is the higher cost associated with multiple orifices rather than one orifice. Another disadvantage is the higher cost of labor in producing hydraulic components or assemblies using multiple orifices since each of the orifices is installed individually. The process of stacking multiple orifices also leads to the possibility individual orifices being improperly installed and even the incorrect number of orifices being installed, which in turn affects the volume of fluid flow or the pressure drop across component or assembly Additionally, when utilizing the End of Line test, more precision is needed at the to ensure that the multiple orifices have been installed correctly.

### SUMMARY

Starting from there, the purpose of the present invention is to provide a single component having dual orifices arranged in series that can be fixed in a hydraulic components or assemblies for example between high- and low-pressure zones to reduce flow noise as hydraulic fluid flows therethrough.

This objective is achieved by a dual orifice component as recited in the claims and described in the description that follows.

The dual orifice component according to the invention comprises a plug having a unitary body that defines a central axis and has opposite axial ends. First and second axial holes that are coaxially aligned along the central axis, each of the first and the second axial holes having first and second axially opposite ends. A third hole that extends perpendicular to the central axis and passes at least partially through the plug. The first end of the first axial hole is located at one axial end of the plug, and the second end of the first axial hole communicates with and is open to the third hole. The first end of the second axial hole is located at the other axial end of the plug, and the second end of the second axial hole communicates with and is open to the third hole such that the second ends of the first and the second axial holes are separated from each other by the third hole.

The dual orifice component according to the invention is advantageous in that it is a single component that comprises multiple orifices in series. This simplifies the production of the orifices and the assembly process of fixing the orifices within a hydraulic component as there is only one element that needs to be assembled in the hydraulic component. Since there is only one element to assemble, this results in a smaller chance of assembly errors.

The dual orifice component according to the invention benefits in improved manufacturability because the diameter of each of the dual orifices is larger than a single orifice. Additionally, because the diameter of each orifice is larger in diameter than a single orifice, the dual orifice component according to the invention is more resistant to contamination or rather fouling by particulate matter in the hydraulic fluid.

The dual orifice component is a threaded plug with a central hole drilled along the center axis through the length of the plug. A cross hole or machined slot is drilled or machined in the middle of the plug such that there is an interruption of the drilled central hole, thus dividing the central hole into separate central holes. Each central hole thereby functions as a flow orifice.

### BRIEF DESCRIPTION OF THE DRAWINGS

The accompanying drawings, which are incorporated in and constitute a part of the specification, illustrate various embodiments of the invention and together with the general description of the invention given above and the detailed description of the drawings given below, serve to explain the principles of the invention. The invention will now be described, by way of example, with reference to the accompanying drawings in which:

FIG. 1 is a diagrammatic view of a hydraulic system, assembly or component including a dual orifice component according to the invention;

FIG. 2 is a plan view of a first embodiment of the dual orifice component according to the invention;

FIG. 3 is a cross-sectional view of the dual orifice component according to FIG. 2;

FIG. 4 is a plan view of a second embodiment of the dual orifice component according to the invention; and

FIG. 5 is a cross-sectional view of the dual orifice component according to FIG. 4.

### DETAILED DESCRIPTION

The present invention will be understood by reference to the following detailed description, which should be read in conjunction with the appended drawings. It is to be appreciated that the following detailed description of various embodiments is by way of example only and is not meant to limit the scope of the present invention in any way.

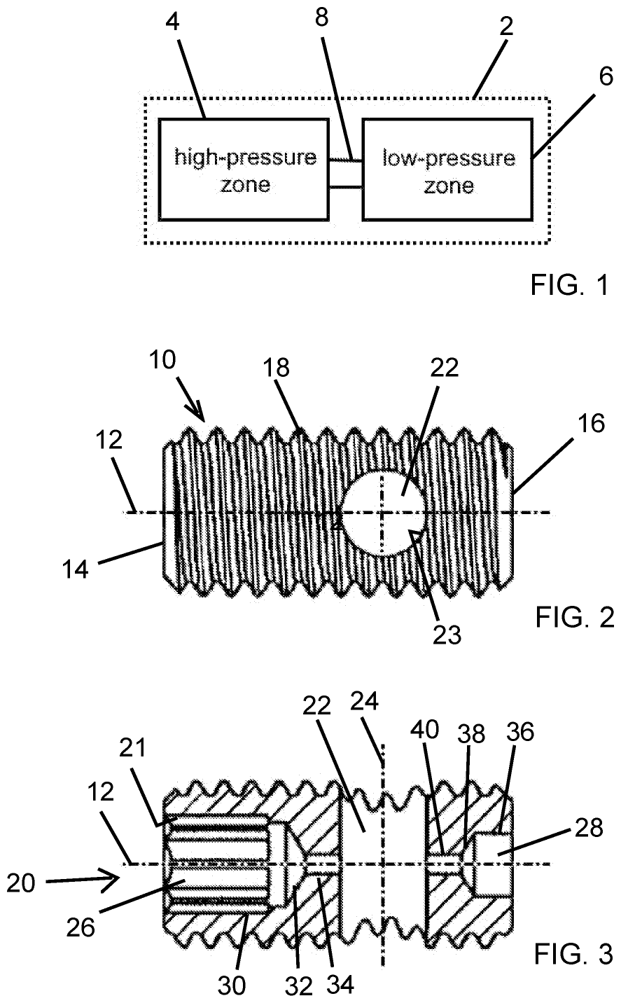

FIG. 1 diagrammatically shows a hydraulic system, assembly, or component 2 having a high-pressure zone 4 and a low-pressure zone 6 that are interconnected to each other in such a manner that hydraulic fluid can flow between the high- and low-pressure zones 4, 6. Connected between the high- and low-pressure zones 4, 6 is a dual orifice component 8 which is used as a path to direct fluid flow from the high-pressure zone 4 to the low-pressure zone 6. As explained in more detail below the dual orifice component 8 is fixed within the hydraulic system, assembly, or component 2 between the high- and low-pressure zones 4, 6. It is to be appreciated that the hydraulic system, assembly, or component 2 can be a hydraulic line, conduit, passage, or pipe that extends between the high-pressure and low-pressure zones, or it can be a valve, fitting, or other component.

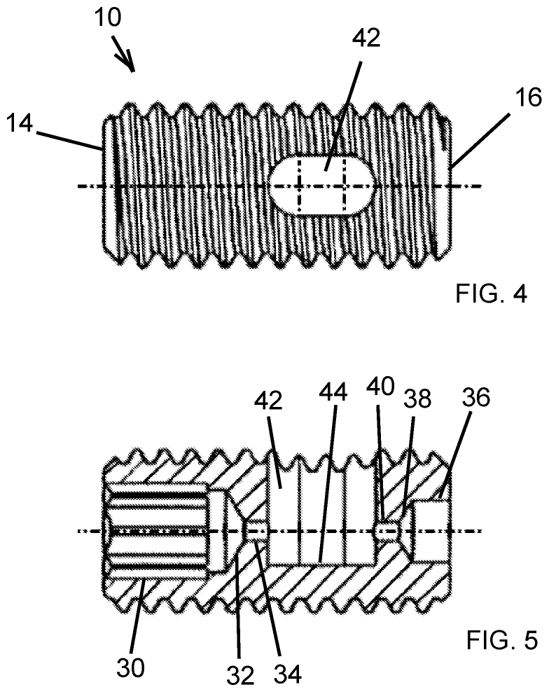

FIGS. 2 and 3 illustrate a dual orifice component 8 which is comprised of a threaded steel plug 10 formed of a unitary body that defines and extends along a central axis 12. The plug 10 has a first axial end surface 14 and an opposite second axial end surface 16 that together define the axial length of the dual orifice component 8. The first end surface 14 of the plug 10 is open to the high-pressure zone 4 and the second end surface 16 is open to the low-pressure zone 6. The axial length of the plug 10 is dependent on many variables such as the pressure differential between the high-pressure zone 4 and the low-pressure zone 6, the target flow rate of the fluid through the dual orifice component 8, and the different characteristics of the orifices and the hydraulic fluid to be utilized with the hydraulic system, assembly, or component 2. It is to be understood that the body of the plug 10 is materially uniform from the first axial end surface 14 to the second axial end surface 16, i.e., along its entire axial length. The body is formed from a single piece of stock material such as a threaded rod or pin. In other words, the plug 10 is not formed by two or more individual components that are connected to each other to form a single body.

The plug 10 has a cylindrical threaded exterior surface 18. The threaded exterior surface 18 facilitates installation of the dual orifice component 8 within an interior surface of a passage in the hydraulic system, assembly, or component 2. The threaded exterior surface 18 has a diameter that corresponds to the diameter of the interior surface of the passage such that when the dual orifice component 8 is screwed into the passage, the respective surfaces mate and fix the dual orifice component 8 within the hydraulic system, assembly, or component 2. By forming the dual orifice component 8 from a single element, installing the orifices in the hydraulic system, assembly, or component 2 is simplified as both orifices are installed simultaneously. Furthermore, the relative arrangement of the orifices relative to each other is consistent.

As best shown in the cross-sectional view of FIG. 3, a central hole 20 is drilled completely through the plug 10 and is defined by annular inner surfaces of the plug 10. The central hole 20 is aligned coaxially with the central axis 12 of the plug 10 and extends in the axial direction, i.e., along the central axis 12 from the first end surface 14 to the second end surface 16 of the plug 10.

The plug 10 also comprises a cross hole 22 that is drilled completely through the plug 10 and defines a lateral axis 24. The lateral axis 24 of the cross hole 22 extends in the radial direction, i.e., perpendicular to the central axis 22 and intersects the central axis 12. The cross hole 22 is defined by a cylindrical surface 23 such that cross hole 22 has a circular profile when viewed in the lateral direction with respect to the plug 10 as shown in FIG. 2. The cross hole 22 extends entirely through the plug 10 and since the lateral axis 24 of the cross hole 22 intersects the central axis 12 of the central hole 20, as shown in FIG. 3, the cross hole 22 interrupts the central hole 20 and divides it into two separate holes. More specifically, the cross hole 22 passes through the central hole 20 and divides the central hole 20 into a first axial hole 26 and a second axial hole 28. The first and the second axial holes 26, 28 are each defined by the annular inner surfaces of the plug 10 which correspondingly define the central hole 20.

The first axial hole 26 comprises first, second, and third axial segments 30, 32, 34 that are connected to each other in order, from the first axial end surface 14 of the plug 10 to the cylindrical surface 23 of the cross hole 22. The first axial segment 30 is defined by an annular inner surface that extends from the first end surface 14 of the plug 10 to the second axial segment 32. As such the central hole 20, or rather the first axial hole 26, is open to the high-pressure zone 4 at the first end surface 14 of the plug 10. The second axial segment 32 is defined by a conical inner surface that axially extends from the first axial segment 30 to the third axial segment 34. The third axial segment 34 is defined by a cylindrical inner surface that extends axially from the second axial segment 32 to the cylindrical surface 23 of the cross hole 22. As illustrated in FIG. 3, the first axial segment 30 has diameter that is greater than a diameter of the third axial segment 34, and the second axial segment 32 has a diameter that decreases in size from the first axial segment 30 to the third axial segment 34. The third axial segment 34 has a diameter that is constant from the second axial segment 32 to the cross hole 22.

In a similar manner, the second axial hole 28 comprises first, second, and third axial segments 36, 38, 40 that are connected to each other in order, from the second axial end surface 16 of the plug 10 to the cylindrical surface 23 of the cross hole 22. The first axial segment 36 is defined by an annular inner surface that extends from the second end surface 16 of the plug 10 to the second axial segment 38. As such, the central hole 20 or rather the second axial hole 28 is open to the low-pressure zone 6 at the second end surface 16 of the plug 10. The second axial segment 38 is defined by a conical inner surface that axially extends from the first axial segment 36 to the third axial segment 40. The third axial segment 40 is defined by a cylindrical inner surface that extends axially from the second axial segment 38 to the cylindrical surface 23 of the cross hole 22. The third axial segment 40 has a diameter that is constant from the second axial segment 38 to the cross hole 22.

With the first axial segment 30 of the first axial hole 26 and the first axial segment 36 the second axial hole 26 being open to the high-pressure zone 4 and low-pressure zone 6. Due to the difference of pressures in the high- and low-pressure zones 4, 6, hydraulic fluid within the hydraulic system, assembly, or component 2 flows through the central hole 20 in the following manner. First the fluid flow enters the first axial hole 30 through the first end surface 14 of the plug 10 and exits the first axial hole 30 from the third axial segment 34 thereof passing into the interior of the cross hole 22. From the interior of the cross hole 22, the fluid flow enters the third axial segment 40 of the second axial hole 28 and exits the second axial hole 28 though the second end surface 16 of the plug 10.

As illustrated in FIG. 3, the first axial segment 36 has diameter that is greater than a diameter of the third axial segment 40, and the second axial segment 38 has a diameter that decreases in in size from the first axial segment 36 to the third axial segment 40. It is noted that the diameters of the third axial segments 34, 40 of the first and the second axial holes 26, 28 are the same and are smaller than the first axial segments 30, 36 of both the first and the second axial holes 26, 28. It is further noted that the diameter of the first segment 30 of the first axial hole 26 is greater than the diameter of the first axial segment 36 of the second axial hole 28. Although the specific diameters of the different axial segments of the first and second axial holes 26, 28 is not specified herein, it is to be appreciated that the diameters of the different axial segments of the first and second axial holes 26, 28 relative to each other facilitate desired flow characteristics through the unitary dual orifice component 8.

The first and second axial holes 26, 28 are spaced from each other, or rather separated, along the central axis 12 by the cross hole 22. In other words, that the axial separation, or rather the axial distance, between the first and second axial holes 26, 28 corresponds to the diameter of the cross hole 22. Due to their axial separation, each of the first and the second axial holes 26, 28 functions as an independent flow orifice. As noted above, the use of two orifices in a component in series between high- and low-pressure zones instead of a single orifice results in the reduction of flow noise as the hydraulic fluid flows through the orifices.

Turning now to FIGS. 4, 5, a second embodiment of the present invention will now be described. As this embodiment is very similar to the previously discussed embodiment, only the differences between this new embodiment and the previous embodiment will be discussed in detail while identical elements will be given identical reference numerals.

The plug 10 according to the second embodiment of the dual orifice component 8 comprises a machined hole 42 that is machined in the plug 10 and extends perpendicular to and intersects the central axis 12 of the plug 10. The machined hole 42 has the profile of a capsule or rather the shape of a rectangle with semicircular opposite ends when viewed in the lateral direction of the plug 10 as shown in FIG. 4. In the lateral direction of the plug 10, the machined hole 42 extends completely through one lateral side of the plug 10 and through the central hole 20 and extends only partially through the other lateral side of the plug 10 as shown in FIG. 5. With this configuration the machined slot 42 has a closed end surface 44. Like the cross hole 22, the machined slot 42 interrupts the central hole 20 dividing it into two separate holes. More specifically the machined hole 42 passes through the central hole 20 and divides the central hole 20 into first and second axial holes 26, 28, as described above. The first and second axial holes 26, 28 are spaced from each other along the central axis 12 by the machined hole 42 such that the axial separation or rather the axial distance between the first and second axial holes 26, 28 corresponds to the axial width of the machined hole 42, i.e., the axial width between opposite axial sides of the machined hole 42. In contrast to the embodiment described above, with the profile of the machined hole 42, the axial distance between the first and second axial holes 26, 28 is greater than the axial distance between the first and second axial holes 26, 28 of the first embodiment. Due to their axial separation, each of the first and the second holes 26, 28 functions as an independent flow orifice which results in the reduction of flow noise as the hydraulic fluid flows through the two orifices of the single component in comparison to that of a single orifice.

The inventive dual orifice component has also been found to simplify the process of assembling a hydraulic system, assembly, or component as only one component is fixed therein while at the same time providing the noted benefits of stack individual orifices. Furthermore, since the assembly of hydraulic systems, assemblies or components only requires the installation of a single dual orifice component there is reduced likelihood of assembly errors. Additionally, the manufacturability of multiple orifices in a single unitary component is improved because the diameter of each orifice is larger in diameter than a single orifice and the dual orifice component has a greater resistance to contamination because the diameter of each orifice is larger than the diameter of a single orifice.

### FURTHER EXAMPLE EMBODIMENTS

The following examples pertain to further embodiments, from which numerous permutations and configurations will be apparent.

Example 1 is a dual orifice component comprising a plug having a unitary body that defines a central axis and has opposite axial ends. First and second axial holes are coaxially aligned along the central axis. Each of the first and the second axial holes has first and second axially opposite ends. A third hole extends perpendicular to the central axis and passes at least partially through the plug. The first end of the first axial hole is located at one axial end of the plug, and the second end of the first axial hole communicating with being open to the third hole. The first end of the second axial hole is located at the other axial end of the plug, and the second end of the second axial hole communicating with and being open to the third hole such that the second ends of the first and the second axial holes are separated from each other by the third hole.

Example 2 includes the dual orifice component of Example 1, wherein the first end of the first axial hole has a first diameter and the second end of the first axial hole has a second diameter, and the first diameter of the first axial hole is greater than the second diameter of the first axial hole.

Example 3 includes the dual orifice component of Example 2, wherein the first end of the second axial hole has a first diameter and the second end of the second axial hole has a second diameter, and the first diameter of the second axial hole is greater than the second diameter of the second axial hole.

Example 4 includes the dual orifice component of Example 3, wherein the second diameters of the first and the second axial holes are the same, and the first diameter of the first axial hole is greater than the first diameter of the second axial hole.

Example 5 includes the dual orifice component of Example 1, wherein the third hole has a circular cross section and extends completely through the plug.

Example 6 includes the dual orifice component of Example 1, wherein the third hole has a capsule shaped cross section that and extends perpendicular to the central axis and only partially through the plug.

Example 7 is a dual orifice component comprising a plug having a unitary body that is materially uniform and defines a central axis and has opposite axial ends. A central hole extends along the central axis completely through the plug. A lateral hole extends perpendicular to the central axis and intersects the central hole, the lateral hole dividing the central hole into first and second orifices. Each of the first and the second axial orifices has first and second axially opposite ends. The first end of the first orifice being located at one axial end of the plug, and the second end of the first orifice communicating with being open to the third hole. The first end of the second orifice is located at the other axial end of the plug, and the second end of the second orifice communicating with and being open to the third hole such that the second ends of the first and the second orifices are separated from each other by the third hole.

Example 8 includes the dual orifice component of Example 7, wherein the first and the second orifices each has a diameter, and the diameter of the first orifice is greater than the diameter of the second orifice.

Example 9 includes the dual orifice component of Example 7, wherein the first end of the first orifice is open to a high-pressure side of the plug and the first end of the second is open to a low-pressure side of the plug such that hydraulic fluid flows through the dual orifice component from the first end of the first orifice to the first end of the second orifice.

Example 10 is a dual orifice component in combination with a hydraulic component, the dual orifice component comprising a plug having a unitary body that defines a central axis and has opposite axial ends. A central hole that extends along the central axis completely through the plug. A lateral hole that extends perpendicular to the central axis and intersects the central hole, the lateral hole dividing the central hole into first and second orifices. Each of the first and the second axial orifices having first and second axially opposite ends. The first end of the first orifice is located at one axial end of the plug, and the second end of the first orifice communicates with and is open to the third hole. The first end of the second orifice is located at the other axial end of the plug, and the second end of the second orifice communicates with and is open to the third hole such that the second ends of the first and the second orifices are separated from each other by the third hole.

Example 11 includes the combination of Example 10, wherein the body of the plug is entirely materially uniform.

The foregoing description of the embodiments of the present disclosure has been presented for the purposes of illustration and description. It is not intended to be exhaustive or to limit the present disclosure to the precise form disclosed. Many modifications and variations are possible in light of this disclosure. It is intended that the scope of the present disclosure be limited not by this detailed description, but rather by the claims appended hereto.

What is claimed is:

1. A dual orifice component comprising:
a plug having a unitary body that defines a central axis and has opposite axial ends;
first and second axial holes that are coaxially aligned along the central axis, each of the first and the second axial holes having first and second axially opposite ends;
a third hole that extends perpendicular to the central axis and passes at least partially through the plug;
the first end of the first axial hole being located at one axial end of the plug, and the second end of the first axial hole communicating with being open to the third hole; and
the first end of the second axial hole being located at the other axial end of the plug, and the second end of the second axial hole communicating with and being open to the third hole such that the second ends of the first and the second axial holes are separated from each other by the third hole.

2. The dual orifice component according to claim 1, wherein the first end of the first axial hole has a first diameter and the second end of the first axial hole has a second diameter, and the first diameter of the first axial hole is greater than the second diameter of the first axial hole.

3. The dual orifice component according to claim 2, wherein the first end of the second axial hole has a first diameter and the second end of the second axial hole has a second diameter, and the first diameter of the second axial hole is greater than the second diameter of the second axial hole.

4. The dual orifice component according to claim 3, wherein the second diameters of the first and the second axial holes are the same, and the first diameter of the first axial hole is greater than the first diameter of the second axial hole.

5. The dual orifice component according to claim 1, wherein the third hole has a circular cross section and extends completely through the plug.

6. The dual orifice component according to claim 1, wherein the third hole has a capsule shaped cross section that and extends perpendicular to the central axis and only partially through the plug.

7. A dual orifice component comprising:
a plug having a unitary body that is materially uniform and defines a central axis and has opposite axial ends;
a central hole that extends along the central axis completely through the plug;
a lateral hole that extends perpendicular to the central axis and intersects the central hole, the lateral hole dividing the central hole into first and second orifices;
each of the first and the second axial orifices having first and second axially opposite ends;
the first end of the first orifice being located at one axial end of the plug, and the second end of the first orifice communicating with being open to the third hole; and
the first end of the second orifice being located at the other axial end of the plug, and the second end of the second orifice communicating with and being open to the third hole such that the second ends of the first and the second orifices are separated from each other by the third hole.

8. The dual orifice component according to claim 7, wherein the first and the second orifices each having a diameter, the diameter of the first orifice is greater than the diameter of the second orifice.

9. The dual orifice component according to claim 7, wherein the first end of the first orifice is open to a high-pressure side of the plug and the first end of the second is open to a low-pressure side of the plug such that hydraulic fluid flows through the dual orifice component from the first end of the first orifice to the first end of the second orifice.

10. A dual orifice component in combination with a hydraulic component, the dual orifice component comprising:
a plug having a unitary body that defines a central axis and has opposite axial ends;
a central hole that extends along the central axis completely through the plug;
a lateral hole that extends perpendicular to the central axis and intersects the central hole, the lateral hole dividing the central hole into first and second orifices;
each of the first and the second axial orifices having first and second axially opposite ends;
the first end of the first orifice being located at one axial end of the plug, and the second end of the first orifice communicating with being open to the third hole; and
the first end of the second orifice being located at the other axial end of the plug, and the second end of the second orifice communicating with and being open to the third hole such that the second ends of the first and the second orifices are separated from each other by the third hole.

11. The dual orifice component according to claim 10, wherein the body of the plug is entirely materially uniform.
